(19) United States
(12) Patent Application Publication
(10) Pub. No.: US 2024/0362367 A1
(43) Pub. Date: Oct. 31, 2024

(54) Method for Using Blockchain Technology to Verify Authenticity and Ownership of Valuable Items such as Luxury Watches

(71) Applicant: Stephen Allen, Frisco, TX (US)

(72) Inventor: Stephen Allen, Frisco, TX (US)

(21) Appl. No.: 18/139,488

(22) Filed: Apr. 26, 2023

(51) Int. Cl. G06F 21/64; G06Q 20/36; G06Q 30/06

(52) U.S. Cl. CPC G06F 21/64; G06Q 20/36; G06Q 30/06

(57) ABSTRACT

An improved method for verifying the authenticity and ownership of valuable items. A valuable item is identified. The valuable item includes valuable item information data, which is information relating to the authenticity of the valuable item and information relating to the ownership of the valuable item. A server computer is acquired. The server computer is programmed to receive communication from a website administrator and website members. A website administrator computer is acquired. The website administrator computer is connected via the Internet to the server computer. The website administrator computer is programmed to communicate with a blockchain website for the purpose of purchasing blockchain tokens from the blockchain website. An administrative digital wallet is created and the administrative digital wallet receives, holds and transfers the tokens. A member computer is acquired. The member computer is connected via the Internet to the server computer. The member computer includes a member digital wallet. The member computer is programmed to transmit purchasing information for purchasing assistance in adding valuable item information to the blockchain. The member computer is also programmed to receive tokens from the administrative digital wallet to be held in the member digital wallet. The tokens are used to register the valuable item information data onto the blockchain.

The present invention relates to blockchain technology, and in particular to methods for making blockchain technology more accessible to members of the general public to protect their valuable items, such as luxury watches.

### BACKGROUND OF THE INVENTION

### Blockchain

Blockchain is known in the prior art. Blockchain is a shared, immutable ledger that facilitates the process of recording transactions and tracking assets in a business network. An asset can be tangible (a house, car, cash, land) or intangible (intellectual property, patents, copyrights, branding). Virtually anything of value can be tracked and traded on a blockchain network, reducing risk and cutting costs for all involved.

Primary Obstacle with Using Blockchain Technology While Blockchain is known and growing in popularity, efficient Blockchain utilization requires significant technical knowledge by the user making it difficult for many members of the general public to use. Multiple technical steps are required by the user to add data to the Blockchain. For example, a user must download the MetaMask app in his browser to perform the transaction of adding data to the Blockchain. MetaMask is a decentralized, non-custodial Ethereum-based wallet that allows users to store, buy, send, convert, and swap crypto tokens. The wallet is available as a mobile app and browser extension on Google Chrome, Firefox, Opera, and Brave. Next, the user must then procure a digital wallet. Then the user must purchase cryptocurrency or tokens. Then the user must add the purchased cryptocurrency or tokens into his digital wallet. Finally, the user can access his tokens in the MetaMask app he downloaded in his browser which can now be used to interact with Blockchain decentralized applications such as adding data to the Blockchain. Data is then placed on the Blockchain and can be verified on the Polygon network.

### Luxury Watches

Luxury watches are a well-known commodity and are desirable investment pieces. They are also very attractive to thieves and counterfeiters. If buying a watch, the buyer must be careful that he is purchasing a product that is authentic and whose ownership can be verified with confidence. Unfortunately, in modem society there is a big problem with fraud, thievery and dishonesty in the luxury watch market.

What is needed is a simpler, more efficient method of adding data to the blockchain so as to better verify authenticity of valuable collectible items, such as luxury watches.

### SUMMARY OF THE INVENTION

The present invention provides an improved method for verifying the authenticity and ownership of valuable items. A valuable item is identified. The valuable item includes valuable item information data, which is information relating to the authenticity of the valuable item and information relating to the ownership of the valuable item. A server computer is acquired. The server computer is programmed to receive communication from a website administrator and website members. A website administrator computer is acquired. The website administrator computer is connected via the Internet to the server computer. The website administrator computer is programmed to communicate with a blockchain website for the purpose of purchasing blockchain tokens from the blockchain website. An administrative digital wallet is created and the administrative digital wallet receives, holds and transfers the tokens. A member computer is acquired. The member computer is connected via the Internet to the server computer. The member computer includes a member digital wallet. The member computer is programmed to transmit purchasing information for purchasing assistance in adding valuable item information to the blockchain. The member computer is also programmed to receive tokens from the administrative digital wallet to be held in the member digital wallet. The tokens are used to register the valuable item information data onto the blockchain.

### BRIEF DESCRIPTION OF THE DRAWINGS

FIG. 1 is a connectivity diagram illustrating the operation of a preferred embodiment of the present invention.

FIG. 2 shows the connectivity of computer systems associated with a preferred embodiment of the present invention.

### DETAILED DESCRIPTION OF THE PREFERRED EMBODIMENTS

For the present invention, the steps of adding data to a Blockchain have been simplified so that an ordinary user with basic computer operating skills can easily add data to the blockchain. In a preferred embodiment the data being added to the blockchain is data verifying ownership and authenticity of a luxury watch owned by the user.

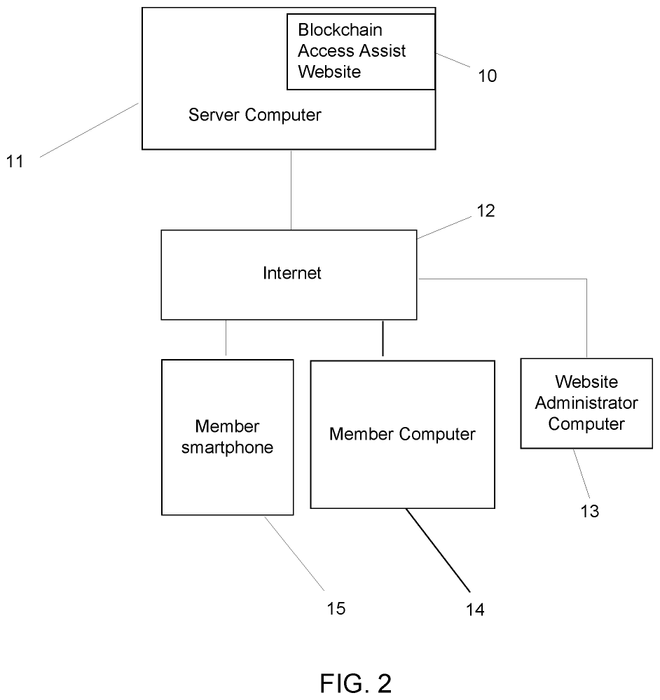

In a preferred embodiment, the user first accesses a blockchain access assist website 10 (FIG. 2) via the Internet. Website 10 is a website that allows a user to add data to the blockchain verifying authenticity and ownership of goods owned by the user (for example, a luxury wrist watch). Then, the user inputs his credit card information to pay a fee to add his data to the blockchain. Then, the user enters the data and relevant images to pre-set fields and then hits submit. The user's data is data is then on the Blockchain and may be easily verified by all users with access to the Blockchain.

In FIG. 2, website 10 is loaded onto server computer 11. Website 10 is assessable via a computer network, such as the Internet 12. Website administrator computer 13 is able to access website 10 for control and administrative purposes. Members operating a computer (such as member computer 14 or member smartphone 15) likewise may access website 10 for the purpose of adding their data to the blockchain in a simple and efficient manner.

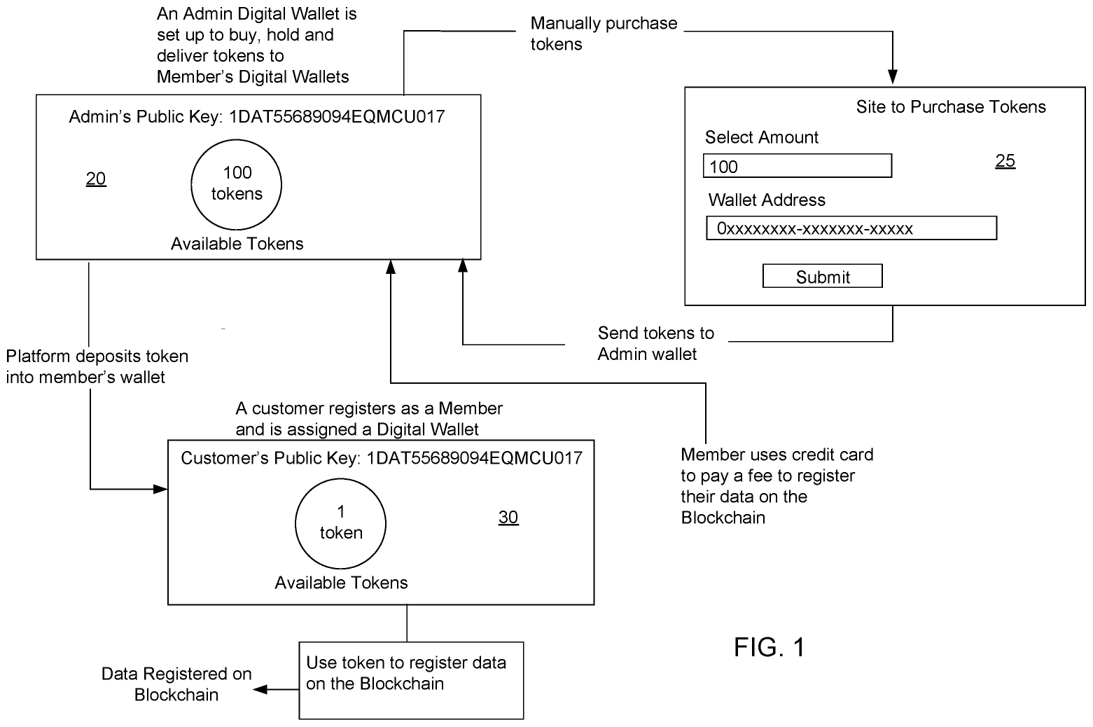

FIG. 1 shows operational connectivity of a preferred embodiment of the present invention. In a preferred embodiment a website administrator utilizing computer 13 to access website 10 creates administrative digital wallet 20. Administrative digital wallet 20 allows the website administrator to buy, hold and deliver tokens to members. For example, in FIG. 1, the website administrator has purchased 100 tokens via blockchain website 25. These tokens are held in digital wallet 20 for later delivery to members.

As illustrated in FIG. 1, a member utilizing computer 14 or 15 (FIG. 2), may use his credit card to pay a fee to the website administrator to register their data on the Blockchain. A user accesses website 10 via the Internet. The user then registers as a member and is assigned a member's digital wallet. To move forward with inputting his data onto the Blockchain, the user inputs his credit card information to purchase one or more tokens. In the example shown in FIG. 1, the user has purchased one token. After the purchase is made, is transferred from administrative digital wallet 20 to member digital wallet 30. The token from member digital wallet 30 is then utilized to transfer the member's data to the blockchain, as shown. In a preferred embodiment the data transferred to the blockchain includes data verifying the ownership and authenticity of a luxury watch owned by the member. Once on the blockchain, the authenticity and ownership of the luxury watch may be easily verified by anyone with access to the blockchain.

Although the above-preferred embodiments have been described with specificity, persons skilled in this art will recognize that many changes to the specific embodiments disclosed above could be made without departing from the spirit of the invention. For example, the above preferred embodiments discussed the utilization of the present invention for the purpose of adding data to the blockchain where the data includes information relating to the authenticity and ownership of luxury watches. It should be understood that in other preferred embodiments, data relating to the authenticity and ownership of other items may be added to the blockchain. For example, data may be added to the blockchain to verify authenticity and ownership of jewelry, artwork, collectable baseball cards, valuable musical instruments, and many more. Therefore, the attached claims and their legal equivalents should determine the scope of the invention.

What is claimed is:

1. An improved method for verifying the authenticity and ownership of valuable items, said method comprising the steps of:
A. identifying a valuable item comprising valuable item information data, said valuable item information data comprising:
i. information relating to the authenticity of the valuable item,
ii. information relating to the ownership of the valuable item,
B. acquiring a server computer, wherein said server computer is programmed to receive communication from a website administrator and at least one website member,
C. acquiring a website administrator computer, wherein said website administrator computer is connected via the Internet to said server computer, said website administrator computer being programmed to communicate with a blockchain website for the purpose of buying blockchain tokens from said blockchain website,
D. creating an administrative digital wallet, wherein said administrative digital wallet receives, holds and transfers said tokens,
E. acquiring a member computer, wherein said member computer is connected via the Internet to said server computer, said member computer comprising a member digital wallet, said member computer being programmed to:
1) transmit purchasing information to said website administrator computer, said purchasing information for purchasing assistance in adding said valuable item information data to the blockchain, and
2) receive at least one token into said member digital wallet, wherein said at least one token is transferred from said administrative digital wallet, and
F. utilizing said at least one token to register said valuable item information data onto said blockchain.

2. The method as in claim 1 wherein said member computer is a smartphone.

3. The method as in claim 1 wherein said server computer further comprises a blockchain assist web site storing said administrative digital wallet and comprising programming facilitating communication between said website administrator computer and said member computer.

4. The method as in claim 1, wherein said valuable item is a luxury watch.
